(19) United States
(12) Patent Application Publication
(10) Pub. No.: US 2016/0071400 A1
(43) Pub. Date: Mar. 10, 2016

(54) Personal incident alert system

(71) Applicant: Nader Nowzari, Richmond Hill (CA)

(72) Inventor: Nader Nowzari, Richmond Hill (CA)

(21) Appl. No.: 14/756,340

(22) Filed: Aug. 31, 2015

Related U.S. Application Data
(60) Provisional application No. 62/070,769, filed on Sep. 5, 2014.

(51) Int. Cl. G08B 25/01; G08B 25/12

(52) U.S. Cl. CPC G08B 25/016; G08B 25/12

(57) ABSTRACT

A personal incident alert system, for alerting aid responders to guide them to a residence where an individual has suffered a personal incident, and having a bulb having a globe portion containing a plurality of low voltage response lights, a base portion attached to the globe containing a plurality of response circuits and connectable to a domestic conventional power supply and adapted to activate the response lights, fastening means on the base portion whereby it is adapted to be received in a conventional domestic electrical lamp receptacle, and, a radio frequency remote controller adapted to communicate with the response circuits in the base portion operable to activate the low voltage response lights.

The invention relates to an alert system for alerting responders as to an incident of a personal nature requiring assistance, and in particular, the location of the person. This application is based on U.S. Provisional 62/070,769, filed Sep. 5, 2014, title PERSONAL INCIDENT ALERT SYSTEM, the priority of which is claimed.

### BACKGROUND OF THE INVENTION

### Field of the Invention

Persons who may be handicapped or partly disabled or simply liable to an accident or a health problem of a personal nature, frequently live in private residences. Often they are alone. If and when a personal incident occurs, in such a private residence, it may be some time before aid responders hear of the incident. In addition, where the incident happens in a personal residence, the responders frequently have difficulty in identifying the particular residence. This is a particular problem where they have a street number requiring illumination.

Such a private residence may have several rooms, and floor levels.

A partly disabled or handicapped person or simply the elderly or otherwise infirm, may live alone is such a residence. For example, if such a person has a fall or a sudden health problem, they may be unable to reach a telephone. If they do reach a telephone it may be difficult to communicate with a 911 service, or a responder.

Numerous communication systems have been proposed and some even marketed, for such handicapped, or other persons liable to be subject to such an incident.

However the systems are largely dependent on, for example, remote communication by telephone.

In cases of an incident requiring assistance, the responders must identify the address of the resident and then find the residence as quickly as possible. Usually in the case of private residences, there will be a front porch and at least one lighting receptacle.

### BRIEF SUMMARY OF THE INVENTION

The invention provides a signalling device, which when activated, can direct aid responders to the residence quickly. In particular the invention provides such a signalling device in the form of an electrical light bulb, which is capable of fitting into a conventional electrical socket, and being powered by the regular electrical power system in the residence through a driver circuit and switches.

Preferably, such a light bulb will incorporate circuitry which will enable the bulb to be either switched on steadily or switched off, or switched to a flashing alert signal. The circuitry in the bulb will respond to remote wireless signals, from a remote personal signalling device, which may be attached to the resident.

The entire system may also have the ability to be connected to an emergency telephone line system already in the residence, enabling the person to communicate with aid responders.

The circuitry is incorporated in the bulb itself. This greatly simplifies installation and use by the resident. All that is required is for them to buy the bulb with the circuits incorporated in it, and to buy a remote control which is capable of communicating with the circuitry within the bulb. In this way, it is not necessary for the purchaser to change the wiring or voltage in the residence, or to install any special antenna or communication wiring in the residence. The remote device carried by the resident will communicate directly with the circuitry in the bulb, using radio frequencies, in a remote manner.

Preferably the bulb circuits will activate an audible alarm, as well as a visual alarm signal.

The entire device may also be provided with a base unit for activating a regular phone line, or a cellular phone connection, which may be connecting via the internet.

In some cases, the circuits may be incorporated in a separate bulb adapter. Such a bulb adapter may simply be a typical screw in bulb base, which can be screwed into the usual domestic bulb socket, and which can incorporate a body containing these circuits, and provided with a threaded bulb receptacle for reception of a standard voltage bulb. In this case, the circuits which respond to the radio frequency remote, will additionally provide for power at the standard voltage to be provided to a bulb, located in the bulb receptacle.

In a further advantageous feature, the base unit may also incorporate a wireless transmission means, for transmitting a signal to a GPS satellite.

In a further modification the alert signalling bulb itself may be provided with a battery operation, so that it does not require to be connected to a household circuit. The battery may be a typical dry storage alkaline or rechargeable battery, or may be a solar powered battery, accumulating solar energy on a daily basis as required.

In a still further modification the alert light system may be incorporated in a typical illuminated house street number, so that upon activation of the wireless remote, the illumination of the house street number starts to flash on and off. Furthermore such a house street number system may also incorporate solar energy and solar battery storage.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a schematic perspective illustration showing a typical residence on a street;

FIG. 2 is a perspective of a bulb incorporating the necessary circuitry;

FIG. 3 is an exploded perspective of the bulb and base;

FIG. 4 is a circuit diagram showing the various components of the bulb circuitry;

FIG. 5 is a schematic perspective illustration of a use of the system with a GPS satellite

FIG. 6 is a perspective illustration showing a form of light incorporating a battery, and solar panels

FIG. 7 is a perspective illustration of a typical house street number sign, incorporating an illuminated street number panel, and flashing LED lights.

FIG. 8 is a perspective illustration of a bulb socket adapter

FIG. 9 is a perspective illustration of a porch light switch, and,

FIG. 10 is a perspective illustration of an alternate form of porch light switch.

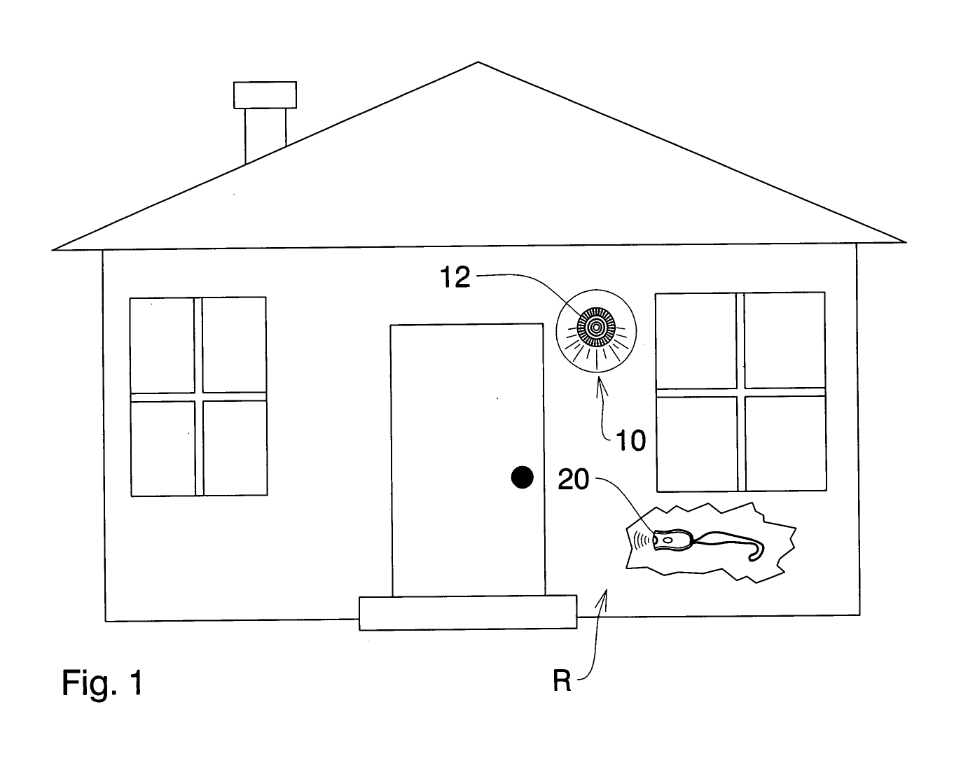

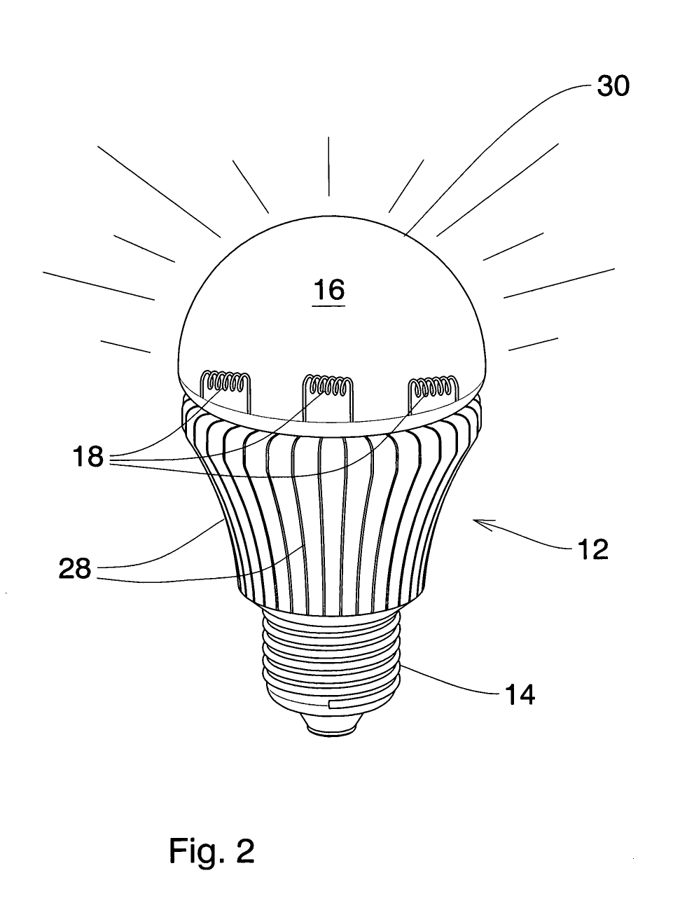

### DESCRIPTION OF A SPECIFIC EMBODIMENT

The invention end product will enable a home owner to place a bulb in an exterior socket such as a porch light (10), typically adjacent to the front door of the residence R.

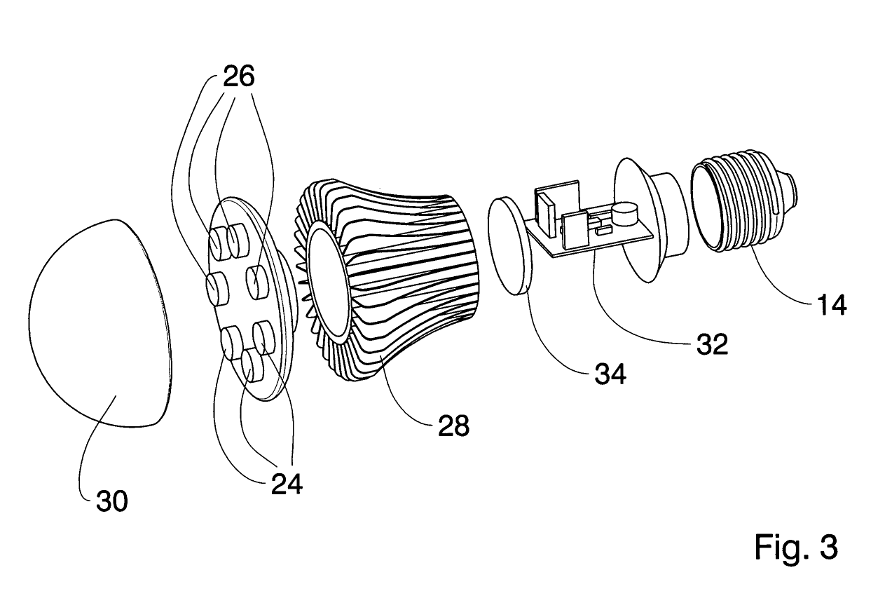

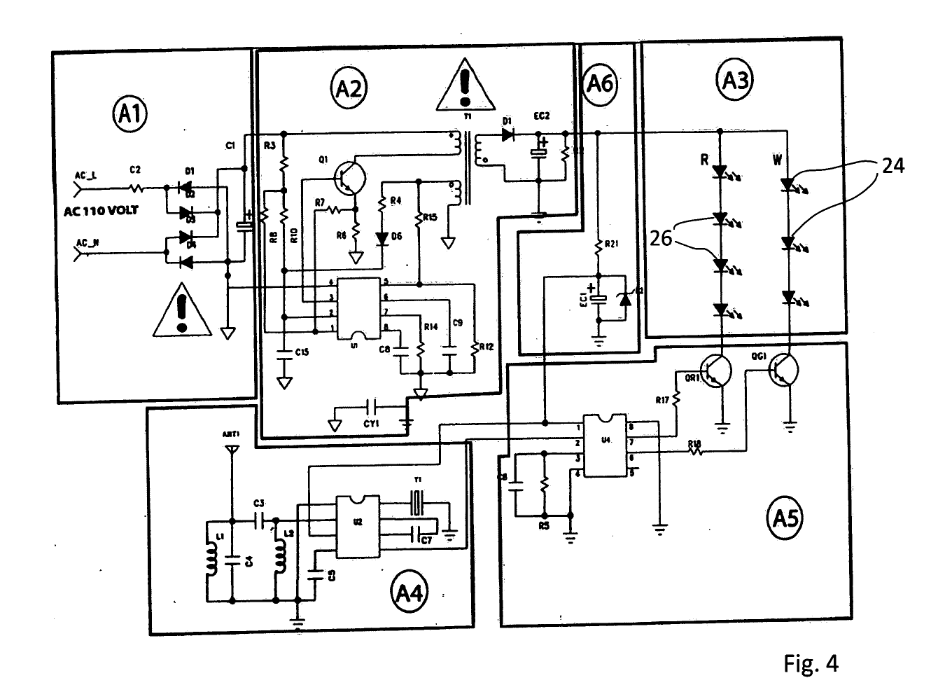

The light socket typically is supplied with the normal residential voltage, in North America being around 110 volts. The light socket is of the conventional socket design, of the screw threaded type, designed to receive a typical regular light bulb. In order to achieve the objective of the invention, a special light bulb (12) is provided (FIG. 3), having an extended base portion (14), and an illumination portion (16) containing special lighting elements (18) for various lighting effects.

The lighting effects may be simply a flashing white light, or maybe alternating red and white lights or the like.

In order for a resident to activate the alert light bulb (12), a suitable remote control (20) is provided. The remote (20) will typically be fitted with a cord (22) which can be worn around the neck.

However other forms of remote are possible, including wrist operation, or a waist band (not shown).

The remote (20) will contain suitable radio frequency circuits such as are well known in the art. Such radio frequency circuits will have a range suitable for transmission throughout the residence, and will be of sufficient strength to reach the control circuits in the bulb itself.

The bulb (12) as explained above has suitable circuitry incorporated in the base (14), to carry out two functions.

The first function is of course to receive the domestic voltage, of alternating current, and convert it to a suitable low voltage, typically around 5 volts, and direct current, so that it is suitable for processing through miniaturized circuits and powering LED lighting elements (18).

The second function is to activate the circuitry in the bulb base (14) responsive to radio frequency signals from the remote, so as to power the elements (18) in the bulb (12), and provide a flashing signal.

It will be appreciated that the elements in the bulb (12) are low voltage, eg. LED units (18) which provide light from low voltage sources. In this case, there are three LEDs (24) which provide white light and four LEDs (26) which provide red light. In this way it is possible to arrange that when it is in use, the alert light will flash alternately red and white, thus providing a distinctive and unique guidance identification for recognition by responders A heat sink (28) is provided and a dome (30) covers the LED's (24, 26).

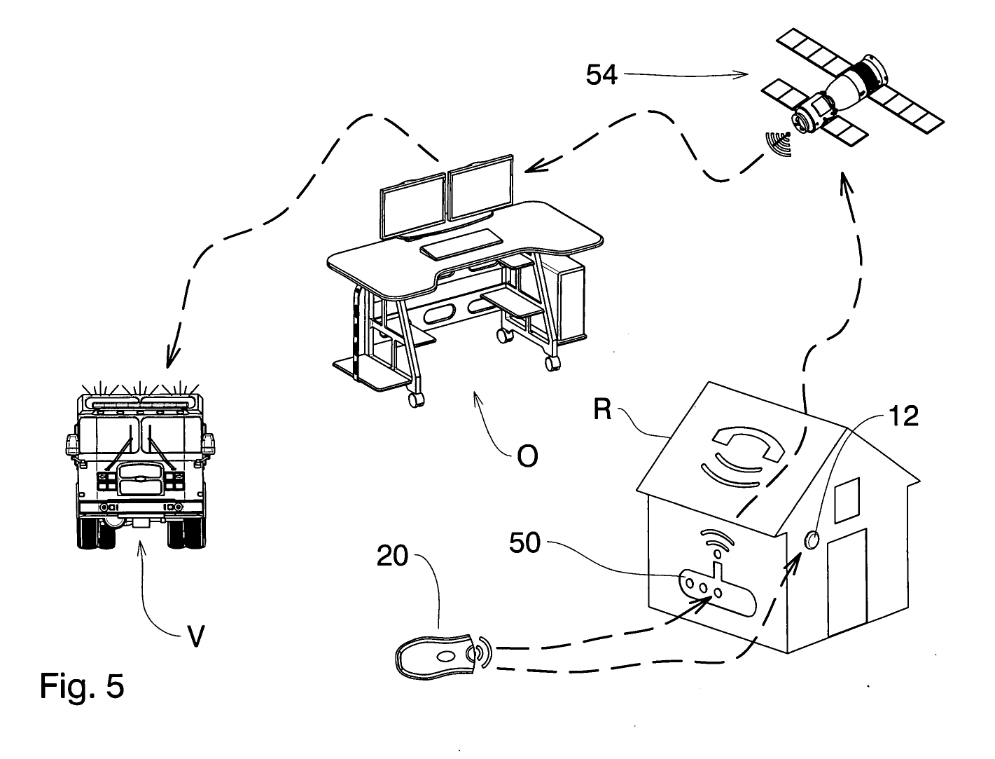

In order to achieve this, the circuits will be seen to comprise (FIG. 5)
A1, a power supply,
A2, an isolating power supply which converts high voltage DC to low voltage DC current and power the LED lights.
A3 shows the LED lights.
A4 is the radio frequency receiver. These components have an antenna and receive signals from the remote, when it is activated.
A6 is a voltage regulator supplying DC power to the receiver.
A5 is a logic switch which controls the switches, for activating the red and/or white LEDs.

All of these circuit components are mounted on a miniature circuit board (32) contained within the bulb base (14).

Within the base (14) a siren sound generator (34) may also be provided. Siren (34) is connected to circuit board (32) and suitable switches, on the board.

The bulb base (14) is, as explained above, provided with a typical screw base fitting, such as is well known in the art, to be screwed into a conventional household electrical lighting socket in North America. Other bases such as pin types may be provided for various designs of sockets.

The remote will require a battery pack to power the radio frequency signals in the event that they are required. The provision of such a remote with a battery pack is well known in the art and requires no special description.

Similar circuits can be provided for incorporation in a telephone alarm system. Such a telephone alarm system will typically incorporate a base unit (50), which is connected to the land line. The base unit (50) will typically incorporate a wireless receiver, for receiving signals from the wireless remote, and may also incorporate a voice system including a microphone, and a speaker (not shown) so that a person may carry on a conversation without actually lifting up a telephone unit.

Thus, when a remote (20) is activated, the unit (50) will send a telephone signal to the responder office and also activate the bulb (12), which is responsive to the typical voltage used in the LED illuminations.

The system can also connect via a cell phone. Such a cell phone connection can be in addition to the bulb and siren. It will provide direct voice connection between the distressed person and a responder.

The system can also be used in conjunction with GPS satellites (54). The base unit (50) would be provided with a transmitter adapted to transmit signals to a satellite. This satellite would in turn retransmit those signals directly to a responder office (O). The responder office could then immediately send GPS location instructions to the responder vehicle (V) which might already be on the road. This will further speed up the arrival of the responder, at the desired location.

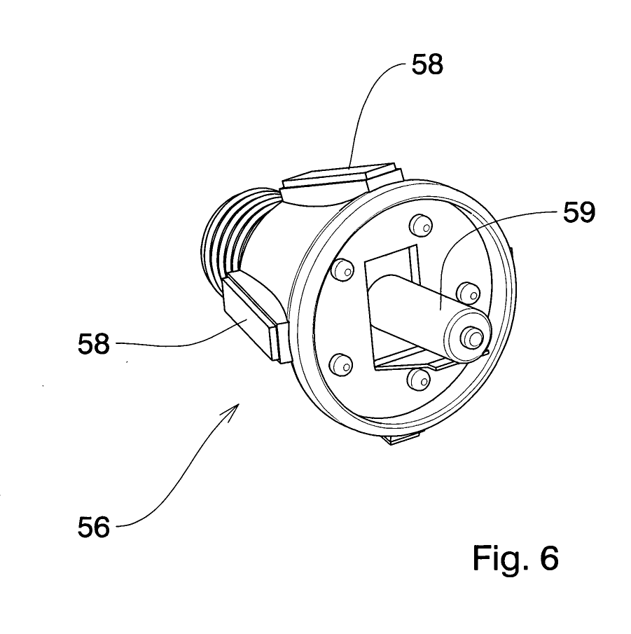

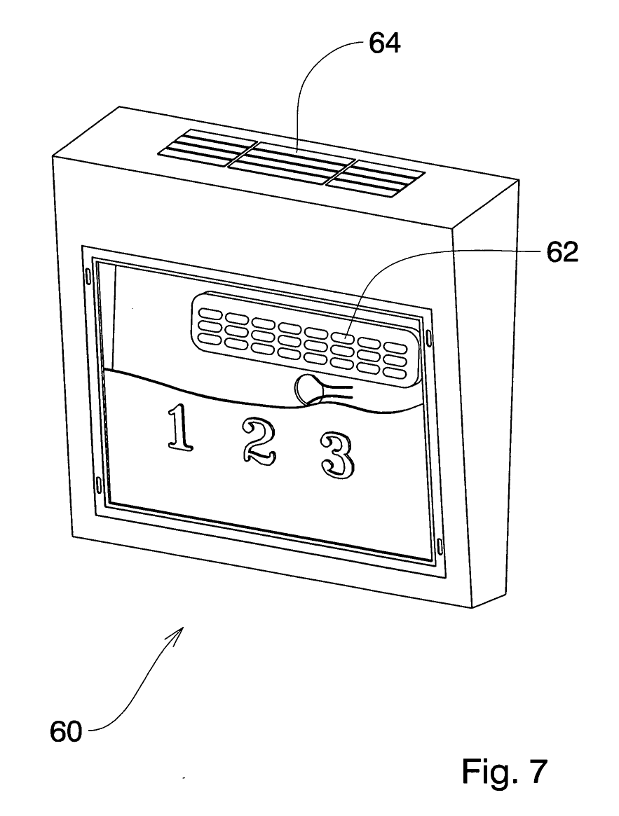

In some cases a porch light (56) FIG. 6 may be operated by solar panels (58) charging a suitable battery (59).

In some cases, houses are provided with illuminated house street number signs (60). In these cases, the house number sign can be modified so as to incorporate LED illumination (62), and may be powered by the domestic power or solar power through solar panel (64). Thus when activated by the wireless remote (20), the house number can then be illuminated by the flashing LED lights, which may for example change colour.

In a more advanced case, it may be possible for the LED lights to provide a word such such as the word help HELP in place of the house number.

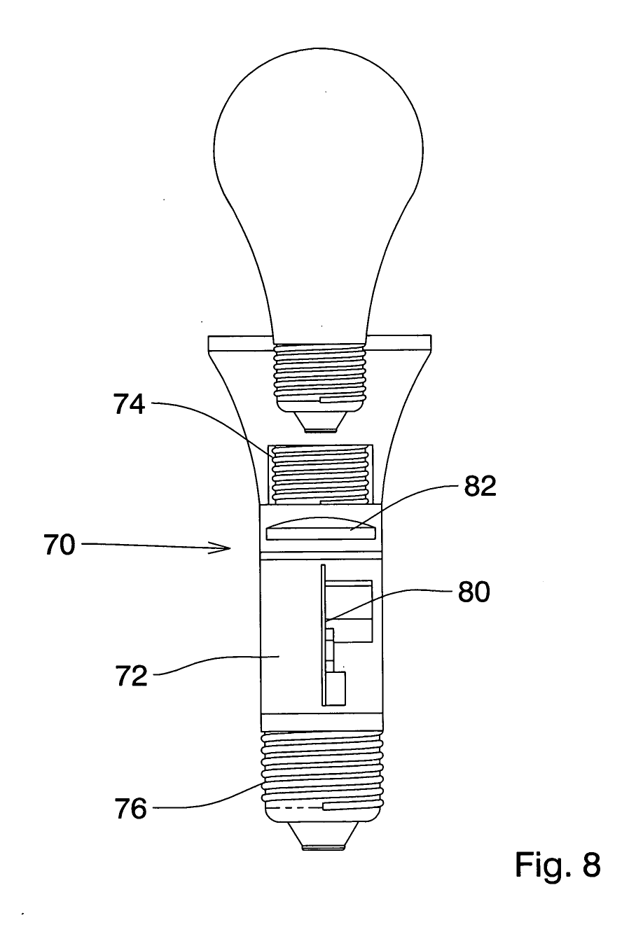

There may be some households who still wish to use a conventional porch illumination. In this case, as shown in FIG. 8), the invention can be incorporated in an adapter (70).

The adapter contains four main parts.
1. A body (72).
2. A socket (74) (screw or pin) to receive and hold the light bulb either by screwing the bulb or twisting it inside the socket.
3. A base (76) screw (or pin) to be screwed or twisted inside the existing porch socket (78) (to convey the power to the driver).
4. A relay chip board (80) installed within the body (72) of the adapter.

The relay responds in this case to 110 AC volt without reducing the voltage, to supply power to a regular 110 AC volt light bulb.

The relay is an auto ON/OFF switch. The switch will cut off the power every 30 seconds from the light bulb.

This action will change any regular household light bulb into a flashing/blinking emergency light. The flashing/blinking time can be set to various time frames such as 80 blinks to 200 blinks per minute. The timing depends on how fast or slow is required.

A siren (82) is also installed in the base to generate a sound effect at the time of emergency. When the light is activated and starts blinking, the siren will start as well.

There may be some householders where there is a porch light, on the front porch of the house, and an interior switch, by means of which the porch light can be switched on or off.

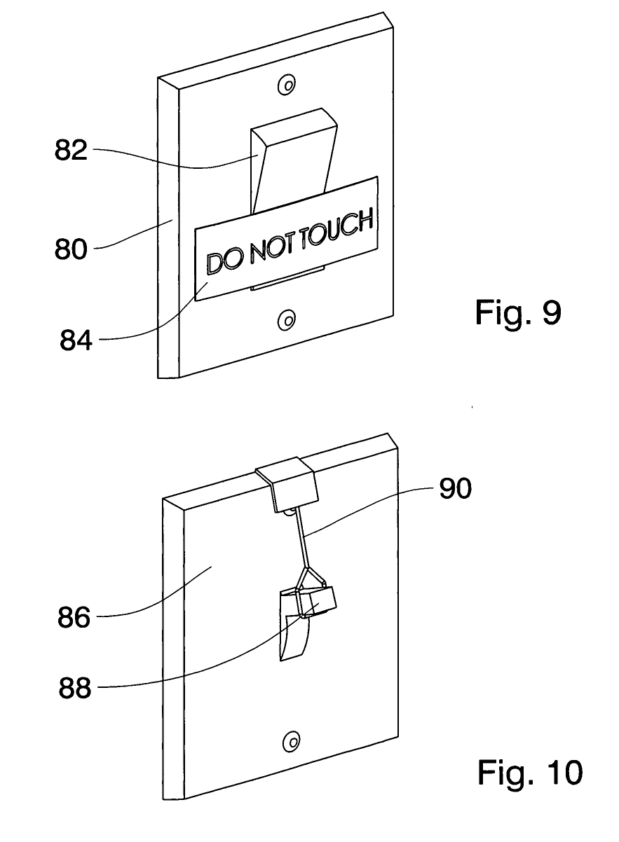

In order to ensure that the alarm system of the invention is available 24 hours a day 7 days a week, the porch light switch should always be left on. In order to assist the resident, FIG. 9 shows a typical switch (80), having a tilt arm (82). In order to hold the tilt arm (82) in the on position, an adhesive label (84) may be provided, acting partly as a reminder and partly as a control of the switch.

In other households, a porch light with the usual toggle switch (86) such as shown in FIG. 10 may be provided. In this case, a toggle switch control (90) may be provided. Such a control (90) as shown in FIG. 10 will have a loop fitting around the toggle (88), and having a clip fitting around the edge of the switch face plate.

It may also be possible to connect a smoke detector (not shown) to the base unit. In this way, if there is a smoke problem detected, an alarm can be sent, automatically. The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A personal incident alert system, for alerting aid responders to guide them to a residence where an individual has suffered a personal incident, and comprising;
a bulb having a globe portion containing a plurality of low voltage response lights;
a base portion attached to the globe containing a plurality of response circuits and connectable to a domestic conventional power supply and adapted to activate said response lights;
fastening means on the base portion whereby it is adapted to be received in a conventional domestic electrical lamp receptacle; and,
a radio frequency remote controller adapted to communicate with said response circuits in said base portion operable to, and activate said low voltage response lights.

2. A personal incident alert system as claimed in claim 1 and including an audible sound device, powered by said response circuits, and operable to emit a sound when said response lights are activated.

3. A personal incident alert system as claimed in claim 2 and including a heat sink, extending between said base and said globe of said bulb.

4. A personal incident alert system as claimed in claim 3 and including a radio signal transmitter in said base unit, responsive to activation of said response lights, to send a radio signal to a satellite.

5. A personal incident alert system as claimed in claim 4 including a telephone land line base unit in said residence, connecting with a telephone land line system, and connectable to a responder, to provide verbal communication.

6. A personal incident alert system as claimed in claim 1 wherein said bulb incorporates a rechargeable electrical storage battery, and solar power panels, adapted to respond to solar energy, and recharge said battery, and said battery in turn supplying power to said response circuits.

7. A personal incident alert system as claimed in claim 6 including a porch light unit attachable to the exterior of said residence, said porch light incorporating low voltage response lighting, and solar panels for powering said response lights.

8. A personal incident alert system as claimed in claim 1 wherein said bulb provides an adapter having a base adapted to be received in a domestic lighting socket, and having a body portion supporting said response circuits, and having a lighting socket member, adapted to receive a domestic bulb.

9. A personal incident alert system as claimed in claim 1 and incorporating a switch control, for controlling an interior domestic porch light switch, whereby to prevent disconnecting of power to said porch light.
